(19) United States
(12) Patent Application Publication
(10) Pub. No.: US 2015/0108109 A1
(43) Pub. Date: Apr. 23, 2015

(54) STEAMER

(71) Applicant: David Menashes, Haifa (IL)

(72) Inventor: David Menashes, Haifa (IL)

(21) Appl. No.: 14/402,864

(22) PCT Filed: May 21, 2013
(86) PCT No.: PCT/IL2013/050442

§ 371 Date: Nov. 21, 2014

Related U.S. Application Data
(60) Provisional application No. 61/649,398, filed on May 21, 2012.

(51) Int. Cl. F22B 1/28; A47J 27/21

(52) U.S. Cl. CPC F22B 1/282; A47J 27/21016
USPC 219/441; 392/398

(57) ABSTRACT

A steam heater comprising: a tube having two ends and interior walls; a heating element extending throughout the tube, wherein a passage is defined by the heating element and the tube interior walls and extends contiguously throughout the tube; a first hollow nozzle coupled to the a first end of the tube; a second hollow nozzle coupled to the second end of the tube; the first nozzle having an orifice facing the heating element; the second nozzle having an orifice facing away from the heating element, the heater having a heating capacity sufficient to convert water entering the passage via the first nozzle into steam leaving via the second nozzle.

### FIELD OF THE INVENTION

The present invention is directed to improved devices for heating water.

### BACKGROUND OF THE INVENTION

WO2009047772 to the inventor describes a steam generating mechanism incorporated within a water heating system having a body, at least one heating element, on/off switch and power supply, the steam generating mechanism comprising:
a hollow tube having a first side and a second side provided close to the at least one heating element; a one way valve connected to said first side, wherein said one way valve allows water to enter into said hollow tube; a one directional pump connected to said second side, wherein the pump is capable of discharging steam generated within said hollow tube; a pipe fluidly connected to said one directional pump wherein said pipe passes through the body for discharging said steam outwardly.

An object of the present invention is to provide improved steam generating devices for the steam generating mechanism of WO2009047772 as well as other systems and apparatuses.

### BRIEF DESCRIPTION OF THE DRAWINGS

FIG. 1 describes a tube having a variable inner diameter and various widgets capable of impeding flow;

FIG. 2 shows two tubes, one inside the other;

FIG. 3A depicts pressurized water entering a steam-heating tube in the form of drops;

FIG. 3B is a drawing of a special nozzle to provide water to the tube;

FIG. 3C depicts another special nozzle in such tube;

FIG. 3D shows a steam heating tube with special baffles to increment heating of the water;

FIG. 3E illustrates revolving baffles in the tube;

FIG. 3F shows three examples of baffles in a tube;

FIG. 4 is a schematic diagram of an electrical circuit for heating water to steam in a tube;

FIG. 5 is an exploded view of a percolator with a steamer;

FIG. 6 is an exploded view of a kettle with a steamer, and

FIG. 7 is an exploded view of a water bar with a steamer;

FIG. 8 shows in perspective view vertical heating element and matching tube, and nozzles and an electrostat, and

FIG. 9 shows in perspective view a horizontal heating element and matching tube, and nozzles and an electrostat.

### DETAILED DESCRIPTION OF THE INVENTION

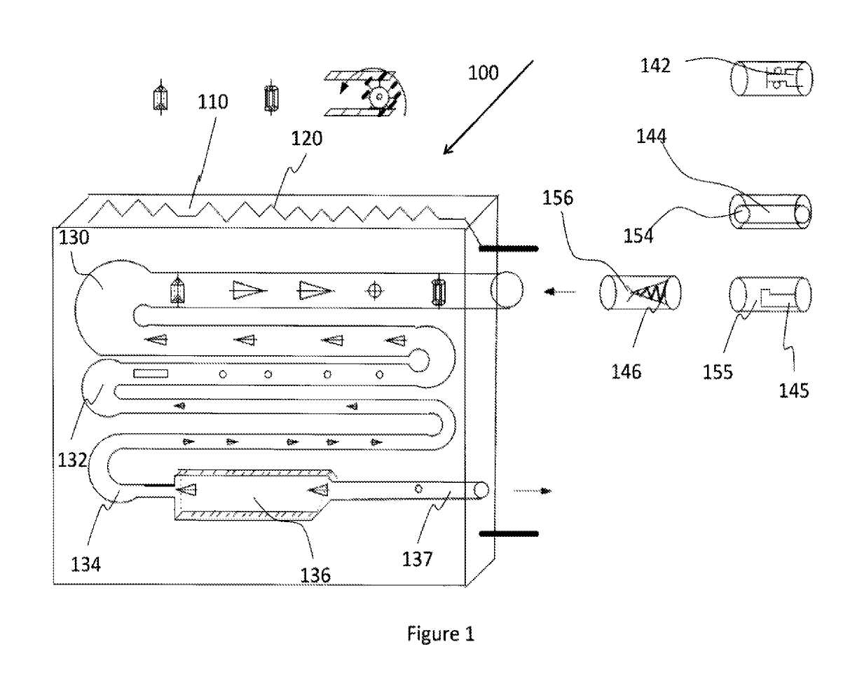

FIG. 1 shows in a schematic drawing a steam heater 100 embodiment. The steam heater includes a heating block 110, a heating element 120, a tube 130, nozzles and baffles, the latter will be described below. The heater 100 also includes a pump, not shown, which feeds pressurized water to the tube 130 and/or siphons steam out of the tube 130. The heater also includes an electrical system discussed below.

The steam heater may be placed under or inside the base of a kettle, in which case the block is typically heated at 1300-2300 Watts.

The entrance 131 of the tube 130 is typically 3-4 mm i.d.; however, the exit 137 is typically 1-3 mm i.d., more preferably 1-2 mm. However, the tube 130 may also have a constriction 134 before an expansion 136, all of these restrictions and expansions may serve to increase heat transfer from the tube 130 to water therein passing from the entrance 131 to the exit 137.

The water is fed to the heater 100 by a pump and/or by gravitation, the water entering the tube via at least one nozzle. One nozzle 142 has a sealed end 152, and openings facing inner walls of the tube entrance 131. Another nozzle 144 has an opening 154 that is as wide as the hole along the nozzle; yet another nozzle 145 has also openings facing the walls of the tube, but has less dead volume than nozzle 142. Nozzle 146 is screw-shaped, with holes along the thread, that may help make the flow of water more turbulent and thus increase the heating rate of the water passing through.

In preferred embodiments, the tube 130 includes at least one coil.

In some embodiments, not shown, the steam heater includes a maze structure through which the water/steam passes; the maze may be constructed from two blocks of heating elements that match each other in grooves and ridges or one block only with a maze structure, that is sealed with a matching plate. Some embodiments may include more than one maze, for example a heating block may be sandwiched in between mazes, such that the water entering a first maze from its periphery goes to a centre point of the maze, having passed through the entire maze first, and then leaves the first maze through a passage which extends from said centre, throughout the heating block and into a centre of a second maze, the water then passing through the entire second maze before exiting as steam. Such heater may include therein the nozzles described above as well as similar nozzles, and baffles discussed below, to further facilitate heat transfer to the water passing through the maze.

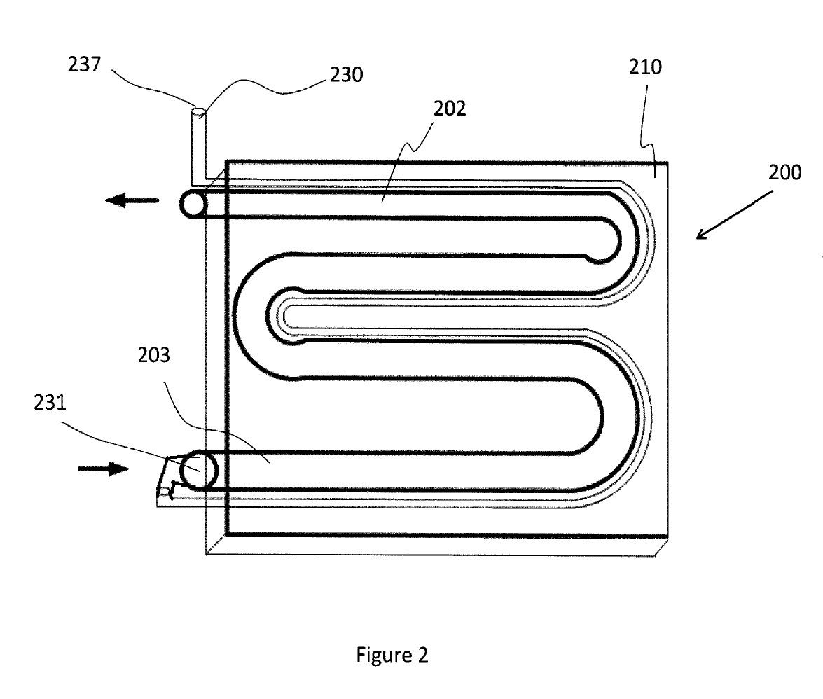

Another embodiment is depicted in FIG. 2. The heater 200 again includes a heating block 210, a heating element (not shown), a tube 130, nozzles and baffles. The heater 200 also includes a pump, not shown, however the pump feeds pressurized water to a first tube 202, into whose end 203 second tube 230 is installed, so that the first tube 202 feeds the second tube 203. In some embodiments, a valve connects first tube 202 to second tube 230. A user may manipulate the valve or a switch operationally coupled to the valve, to select between hot water delivery from the first tube 202, for example for delivery to the kettle or directly to a cup, and hot water delivery to the second tube 230. In some embodiments, there is a booster pump, preferably between the valve and the second tube 230, that may be used to boost the water pressure in the second tube 230. In some embodiments the booster pump automatically operates whenever the switch is set to deliver water to the second tube, e.g. by the same switch that sets delivery of hot water from the first tube to the second tube; in other embodiments the booster pump can be selected to be operated independently from the valve; preferably, in such embodiments, there is a micro-switch to prevent the booster pump from operating when the valve is set to deliver hot water not to the second tube. In some embodiments, the second tube 230 is coiled around the first tube 202.

The heater also includes an electrical system discussed below.

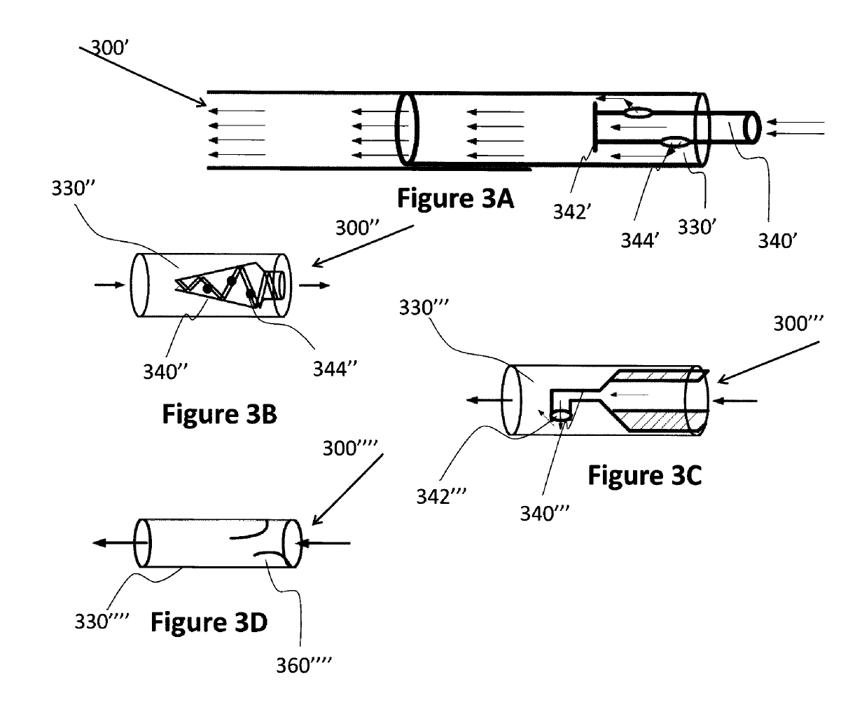

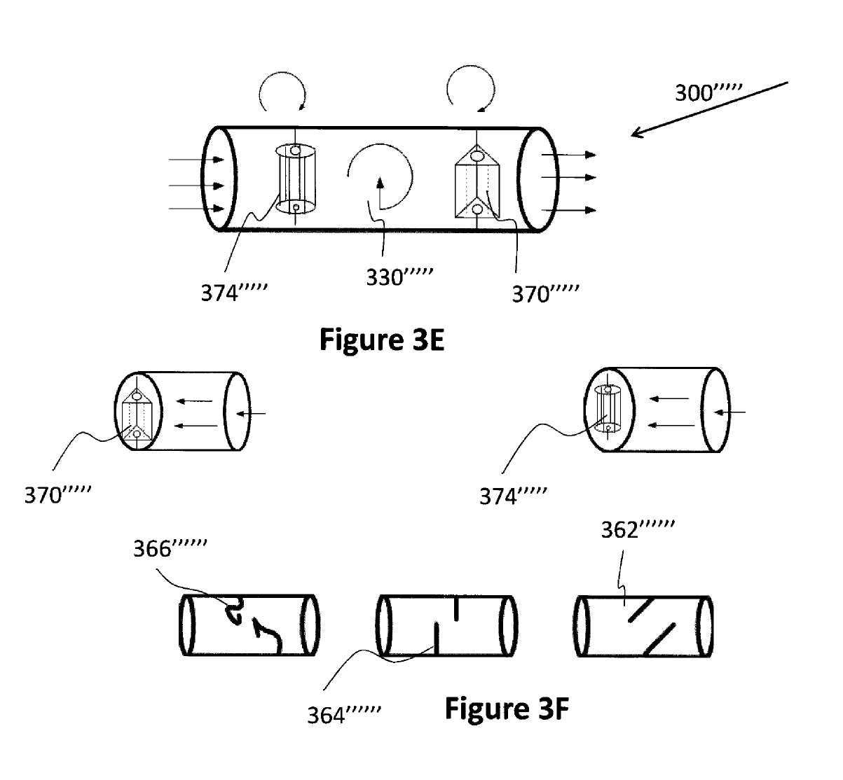

FIG. 3A is a schematic drawing showing part of a heater 300′ with steam tube 330′. The nozzle 340′ is blocked at the end, and has a rim 342′ that extends around the nozzle to leave a narrow space between the inner walls of the tube 330′ and the nozzle 340′. Holes 344′ allow water to exit the nozzle 340′ and impinge upon the inner walls of the tube 330′, before passing through the narrow space.

In the embodiment 300″ the nozzle 340″ is corkscrew-shaped, also blocked at end and with holes 344″, the corkscrew shape and the position of the holes allowing the water to become turbulent, and/or go a long and tortuous path, to facilitate heating of the water, and the water essentially impinges upon the inner walls of the tube 330″.

In another heater 300′″, nozzle 340′″ has a very small-bore end 342′″, open and directed to one spot on the wall. Such spot may be locally heated more than other areas of the tube 330′″.

Heater 300″″ includes in the tube 330″″ stationary baffles 360″″. The baffles 360″″ are preferably opposed to each other to create a narrow space through which the water passes in the tube 330″″.

In another embodiment 300′″″ shown in FIG. 3E shows rotational baffles 370′″″ and/or 374′″″ that are installed in the tube 330′″″. The first baffle 370′″″ is prism-shaped, whereas the second baffle 374′″″ is wheel-shaped. Preferably, the baffles have ridges on surfaces thereof, to facilitate interaction with water passing by the baffles, to further heat the water. Preferably, the baffles are installed in a maze-shaped heating block rather than in a tube, in regard of ease of construction.

As shown in FIG. 3F, three types of stationary baffles 362″″″, 364″″″, 366″″″ are shown. According to the requirements such as energy expenditure efficiency, heater size requirements and restrictions, steam temperature and delivery rate, one or more baffle may be selected.

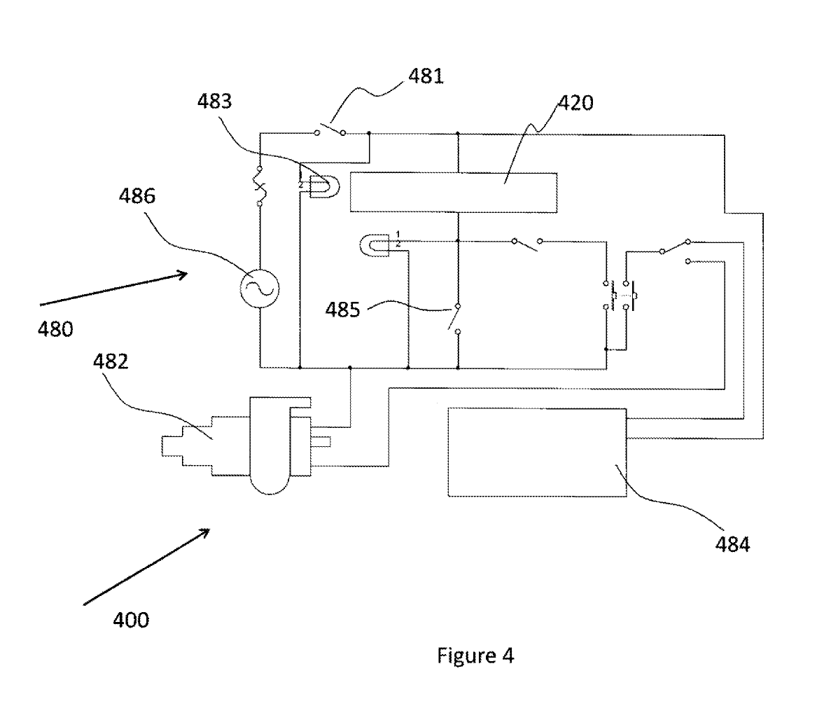

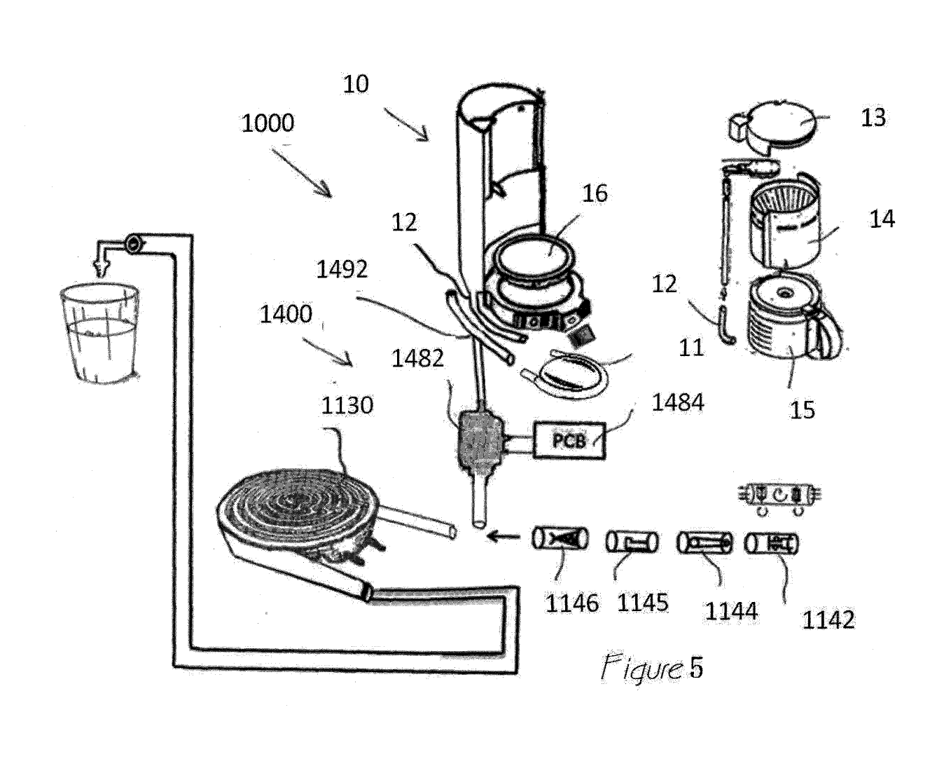

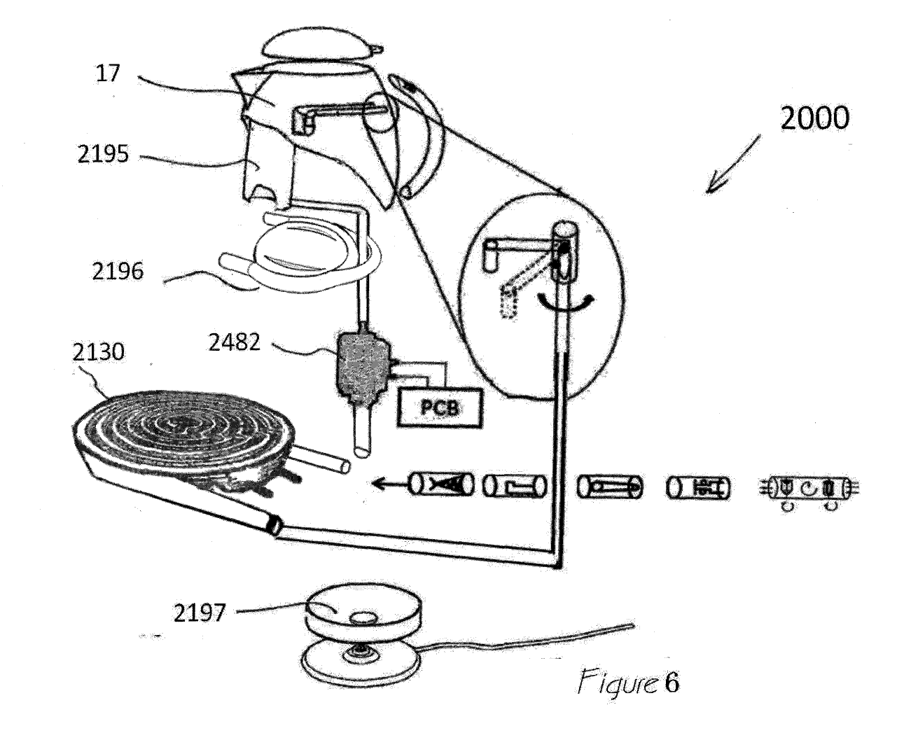

FIG. 4 shows an electrical setup 480 suitable for use in a steam heater embodiment 400. The electrical setup 480 includes the heating element 420, switches 481, a pump 482, indicating lamps 483, a PCB 484, at least one thermostat 485, power supply 486.

Preferably, the electrical setups are set to bring the steam to a certain temperature, in order to optimize the steam for its designated purpose, e.g. to prepare milk froth for coffee. The steam heaters may be incorporated in an electric kettle, or a percolator, or a milk frother, or a water bar such as Tami 4® etc.

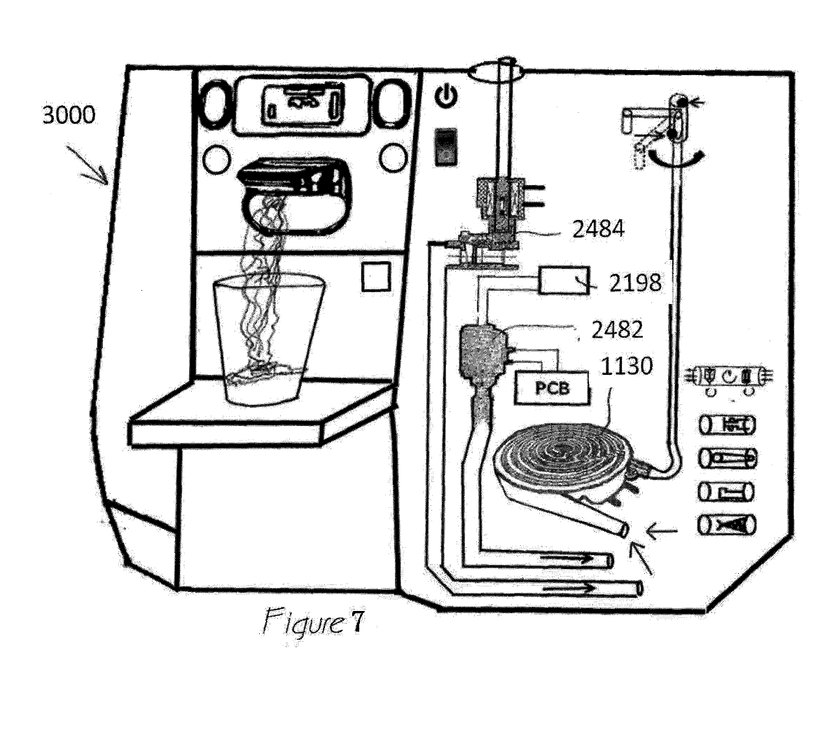

FIG. 5 shows in an exploded view a modified percolator 1000. The percolator has the known container 10, a heater 11 in contact with a steam pipe 12, lid 13, filter holder 14 and coffee receptacle 15 that sits on a holding plate 16. The steamer 1400 comprises a junction 1492, leading from pipe 12 to pump 1482, which when operated provides water to the maze 1130 via a nozzle such as one of nozzles 1142-1146.

FIG. 6 depicts a modified kettle 2000. The kettle 2000 includes a body 17 that is shown in cutout view. A cold-water container 2195 (also shown in cutout view) is situated inside the body 17 that is thermally insulated from the space inside the body 17 and outside the container 2195 such that the water therein is less than 50° C. The kettle has a plate 2196 that in commercially available kettles holds a heating element and seals the bottom of the body 17. However, in contrast to the commercially available plates, plate 2196 has an aperture which allows to fluidly connect the container 2195 with the steamer pump 2482. Water goes from the pump 2482 to the maze 2130. The maze may fit into a bottom plate 2197.

FIG. 7 shows a modified water bar 3000 in which water can be provided for steaming from mains via an electric or manual (or magnetic etc) valve to maze 1130, or from a reservoir 2484 via a pump 2482 to the maze 1130.

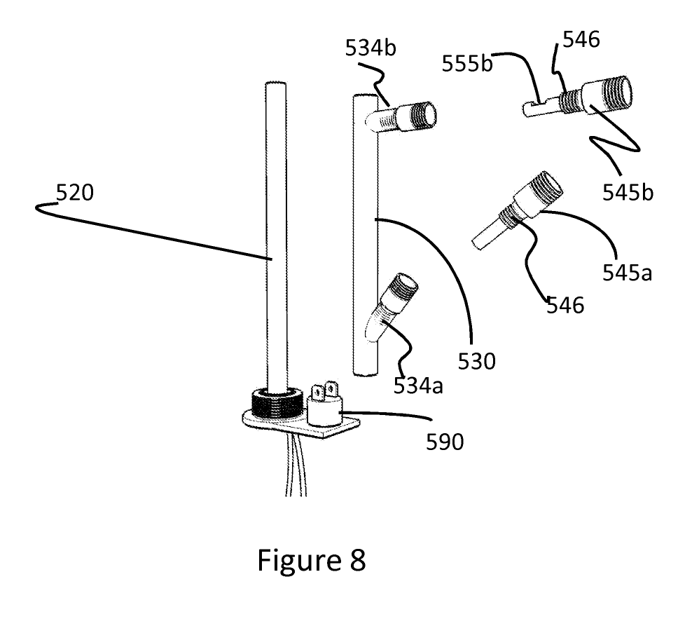

FIG. 8 shows in perspective view a vertical heating element 520 and matching tube 530, and nozzles 545a and 545b and an electrostat 590. The element 520 is vertical in respect to a kettle base (not shown). Water enters via the bottom nozzle 545a, which has an opening (not shown) that faces the heating element 520, i.e. in this particular case the nozzle does have an opening at the end, as the water generally flows in the tube 530 in a different direction. The opening 555b of the top nozzle 545b, from which the steam exits, preferably faces upwards, which is not strictly opposite the direction of the heating element (vertical) but for practical purposes faces away from the heating element. The nozzles 545a and 545b may have threads 546 that match threads (not shown) on branches 534a and 534b on the tube 530, so as to allow firmly screwing the nozzles 545a, 545b to the tube 530, yet allowing easy removal of the nozzles 545a, 545b for cleaning the tube from dirt, scaling from precipitates etc.

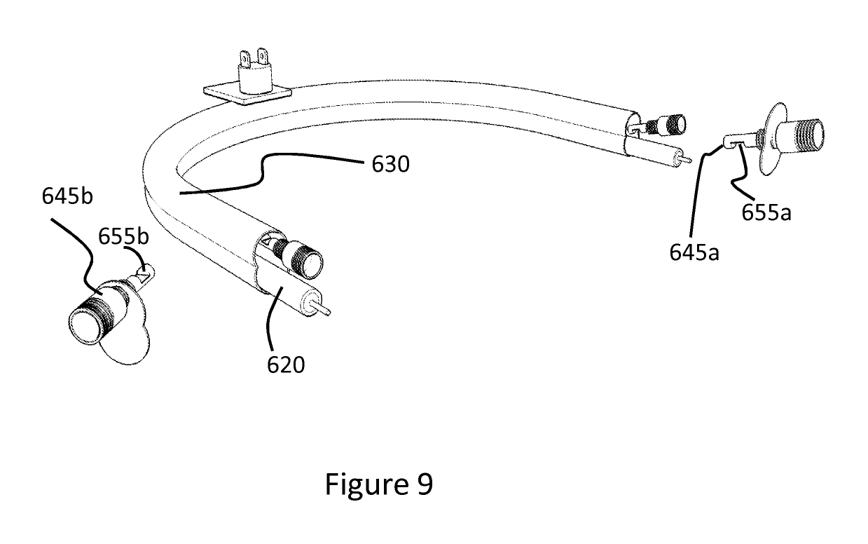

FIG. 9 shows in perspective view a horizontal heating element 620 and matching tube 630, and nozzles 645a and 645b.

The exit nozzles 545b and 645b both have openings 555b and 655b facing upwards, such orientation may help prevent release of liquid from the heater since the liquid may be located mainly at lower parts of the tube 530, 630.

The steam heater with the tubes in horizontal orientation (630) has in preferred kettle embodiments a hollow base (under the body wherein water is normally heated). The heating element and tube is situated inside the base, such that the only access a user has is to a switch operationally coupled to the heater, to allow turning on the steam providing mode. In experiments with such embodiments, wherein the tube 630 was about 250 mm long and had an internal height of 8 mm (between the heating element 520 and the roof of the tube 530 on the inside, the width of the tube typically being somewhat narrower), tap water at about 25° C. was fed by a pump, at a flow rate corresponding to a pressure of about 5 bar. A sufficient amount of steam was produced within 10-20, enough to satisfactorily cream a cup of coffee.

Typically, the heating element 520, 620 has a power of 600-900 W to provide a desirable amount of steam in this embodiment.

While preferred embodiments have been described, the invention is only limited by the scope of the claims.

Those skilled in the art will recognize that the method and system of the present invention has many applications, may be implemented in many manners and, as such, is not to be limited by the preceding and following exemplary embodiments and examples. Additionally, the functionality of the components of the preceding and following embodiments may be implemented in different manners. Further, it is to be understood that the steps in the embodiments may be performed in any suitable order, combined into fewer steps or divided into more steps. Thus, the scope of the present invention covers conventionally known and future developed variations and modifications to the system components described herein, as would be understood by those skilled in the art.

1. A steam heater comprising a heating element, a passage therein with internal walls, the passage having an entrance and an exit, a nozzle having at least one nozzle hole at the entrance, at least one of the nozzle holes facing one of the internal walls, the steam heater configured to allow heating water entering the passage into steam.

2. A steam heater comprising:
a tube having a first end, a second end and interior walls;
a heating element extending throughout the tube, wherein a passage is defined by the interior walls and the contiguous heating element and extends throughout the tube;
a first hollow nozzle coupled to the first end of the tube wherein the first nozzle has an orifice facing the heating element;
a second hollow nozzle coupled to the second end of the tube wherein the second nozzle has an orifice facing away from the heating element;
wherein the steam heater has a heating capacity sufficient to convert water entering the passage via the first hollow nozzle into steam leaving via the second hollow nozzle.

3. The steam heater of claim 1, wherein the passage is a maze made of two complementary heating blocks.

4. The steam heater of claim 1, wherein the passage is a first tube.

5. The steam heater of claim 1, wherein the passage comprises a first tube and a second tube, wherein the first tube has an inner diameter smaller than an inner diameter of the second tube, and wherein the heater comprising a nozzle connecting the second tube to the first tube, and wherein the steam heater is capable of turning water into steam in the first tube.

6. The steam heater of claim 4, wherein the first tube is partly inside the second tube.

7. The steam heater of claim 5, wherein the second tube is partly wrapped around the first tube.

8. The steam heater of claim 1, further comprising a thermostat configured to regulate the temperature of the steam to a predetermined desired temperature.

9. The steam heater of claim 4, wherein a valve connects the second tube to the first tube, and wherein the heater configured to allow switching the heater from supplying hot water to supplying steam and back to supplying hot water, by manipulation of the valve.

10. A kettle comprising the heater of claim 1.

11. The kettle of claim 1, wherein the heater is in a base of the kettle.

12. The heater of claim 4, wherein the first tube has an inner diameter of 1-2 mm.

13. The heater of claim 1, further comprising baffles within the passage.

14. The heater of claim 13, wherein at least one of the baffles is revolvable by flow of water in the passage.

15. The heater of claim 14, wherein the baffles comprise a form selected from a group comprising a prism and a ridged wheel.

16. The heater of claim 1, further comprising a pump capable of pressurizing water entering the passage.
